(19) United States
(12) Patent Application Publication
(10) Pub. No.: US 2026/0366444 A1
(43) Pub. Date: Nov. 19, 2026

(54) THERMAL ENHANCER FOR EXHAUST AFTERTREATMENT APPARATUS

(71) Applicant: Purem Novi, Inc., Novi, MI (US)

(72) Inventors: Jack Riddle, II, Brighton, MI (US); Hyde Kani, Northville, MI (US); Todd Stolaruk, West Bloomfield, MI (US); Bob Turkovich, Brighton, MI (US)

(21) Appl. No.: 19/132,285

(22) PCT Filed: Nov. 22, 2023
(86) PCT No.: PCT/US2023/080927

§ 371 Date: May 22, 2025

Related U.S. Application Data
(60) Provisional application No. 63/427,251, filed on Nov. 22, 2022.

(51) Int. Cl. F01N 3/20; B01D 46/82; B01D 53/94; F01N 3/023

(52) U.S. Cl. CPC F01N 3/2066; B01D 46/82; B01D 53/9418; B01D 53/944; F01N 3/023; B01D 2251/208; B01D 2258/012; F01N 2610/03; F01N 2610/1453

(57) ABSTRACT

An exhaust aftertreatment apparatus having: a) a reactor portion with an inlet configured to receive an exhaust stream and opposite of an outlet, wherein the flow axis is substantially concentric with the reactor portion; b) an evaporation device configured to be in receiving fluid communication with a fluid delivery device and comprising: i) an outer wall; ii) a plurality′ of openings formed in the outer wall; iii) closed end; and wherein the evaporation device is configured to receive a reactant in liquid form from the fluid delivery device and allow the reactant to vaporize into gas form before exiting from the plurality of openings and mixing with the exhaust stream in the reactor portion.

### FIELD

The present teachings relate to an exhaust system. The exhaust system may find particular use as an exhaust aftertreatment system. The exhaust system may find particular use with aftertreatment hydrocarbon injection in diesel combustion systems. The exhaust system may include one or more reactor portions advantageous as a thermal enhancer.

### BACKGROUND

Generally, internal combustion engines produce an exhaust stream having toxic gases and pollutants within the exhaust stream. Agencies across the world, such as the United States Environmental Protection Agency, have enacted regulations regarding the exhaust emissions, seeking to reduce the toxic gasses and pollutants. It is now typical that transportation vehicles (e.g., commercial vehicles, such as trucks) are equipped with exhaust aftertreatment systems configured to remove or reduce the toxic gasses and pollutants within the exhaust stream prior to emission of the exhaust stream to the atmosphere. Vehicles having diesel combustion systems are most often equipped with such aftertreatment systems.

In efforts to meet stringent emission requirements, it has become common to perform one or a series of chemical reactions within the exhaust system. It is common to perform selective catalytic reduction (“SCR”). That reaction typically seeks to convert (by a reduction reaction) one or more nitrogen oxides found in an exhaust stream into benign nitrogen gas and water. It is also common to employ a diesel particulate filter (“DPF”). A diesel particulate filter generally removes particulate matter (e.g., diesel particular matter) or soot from the exhaust stream. A diesel particulate filter may undergo filter regeneration. A catalyst may be used in conjunction with a diesel particulate filter to burn off accumulated particulates within the filter, or a fuel burner may be used in conjunction with the filter to actively burn the particulates. Such a catalyst may include a diesel exothermic catalyst (“DEC”), a diesel oxidation catalyst (“DOC”), or both. A diesel exothermic catalyst, diesel oxidation catalyst, or both may be packaged in a single reactor portion along with the diesel particulate filter to provide for the filter regeneration. As a result of the various chemical and filtering reactions, a typical exhaust system is required to effectively function as a chemical reaction system, pursuant to which each of the chemical reactions is performed in a portion (“reactor portion”) of the after-treatment system. Separation(s) may be performed within a reactor portion or within a separate portion.

A challenge presented by known exhaust aftertreatment systems is the overall space required to integrate the exhaust system into a transportation vehicle. Typically, in-line exhaust aftertreatment systems will incorporate a series of reactor portions and filter(s) in a generally straight exhaust stream flow path configuration sharing a single, common flow axis along the length of the reactor portions. To achieve such functionality, along with the straight flow path of the exhaust stream, it may necessarily require that the system extend along almost an entire length of a vehicle from a motor to the rear of the vehicle. This can become complex in integrating the exhaust after-treatment system with other vehicle components (e.g., brake lines, fuel tank, fuel lines, suspension system, electrical wiring, etc.) or cargo storage areas (such as the case with heavy duty trucks). In essence, there are two competing interests with inline exhaust aftertreatment systems, sufficient length to allow for reactants to uniformly mix with the exhaust stream and result in the desired chemical reactions and a small enough size to be adaptable to be integrated in varying transportation vehicles and efficiently using space.

As gleaned from the above, reactor portions in exhaust systems typically employ a catalyst which reacts with the exhaust stream passing therethrough. The employment of catalysts tends to be dimensionally dependent (e.g., length, width, height, area and/or volume dependent), as well as possibly being temperature dependent in order that chemical reactants be sufficiently exposed to a catalyst at a desired reaction temperature to achieve the desired reaction. For example, successful filter regeneration and burning off of particulate matter often requires that a stream of a reactant (e.g., hydrocarbon) be injected and mixed with an exhaust stream. Successful and thorough mixing within a short exhaust stream flow path to support filter regeneration has posed technical challenges. Accordingly, achieving the potentially multiple objectives for a successful mixing and/or chemical reactions within a compact packaging space has produced various competing technical challenges.

### SUMMARY

An exhaust aftertreatment apparatus having: a) a reactor portion with an inlet configured to receive an exhaust stream and opposite of an outlet, wherein the flow axis is substantially concentric with the reactor portion; b) an evaporation device configured to be in receiving fluid communication with a fluid delivery device and comprising: i) an outer wall; ii) a plurality of openings formed in the outer wall; iii) an end cap; and wherein the evaporation device is configured to receive a reactant in liquid form from the fluid delivery device and allow the reactant to vaporize into gas form before exiting from the plurality of openings and mixing with the exhaust stream in the reactor portion.

The present teachings may provide for a reactant which is a thermal enhancer and can maintain and/or increase the temperature of a exhaust stream as it flows through the exhaust aftertreatment apparatus. The reactant may also be beneficial in providing for chemical reactions downstream after mixing with the exhaust stream. The present teachings may provide for one or more evaporation devices. The evaporation device(s) may be located between a point of delivery of a reactant (e.g., fluid delivery device) and an exhaust stream flowing through a reactor portion. The evaporation device may be beneficial in functioning as a thermal conductor, raising a temperature of a reactant, vaporizing a reactant, or both. In such a manner, the reactant may be introduced into an exhaust stream with minimal to no negative impact (e.g., cooling off) the exhaust stream, and instead may aid in maintaining and/or increasing the temperature of the exhaust stream, more uniform mixing with the exhaust stream, and/or more uniform temperature across the exhaust stream. This may allow for more efficient reactions and operations downstream in further reactor portions, and even smaller lengths in reactor portions.

### BRIEF DESCRIPTION OF DRAWINGS

FIG. 1 is a transparent view of an exhaust aftertreatment apparatus.

FIG. 2 is a cross-section view of an exhaust aftertreatment apparatus.

FIG. 3 illustrates an evaporation device.

FIG. 4 illustrates both an evaporation device and a mixing device.

FIG. 5 illustrates an exhaust stream through an exhaust aftertreatment apparatus.

FIG. 6 is a transparent view of an exhaust aftertreatment apparatus.

FIG. 7 illustrates an exhaust stream through an exhaust aftertreatment apparatus.

FIG. 8 is a cross-section view of an exhaust aftertreatment apparatus.

FIG. 9 illustrates an exhaust stream through an exhaust aftertreatment apparatus.

FIG. 10 is a cross-section view of an evaporation device.

FIG. 11 is a perspective view of an evaporation device.

FIG. 12 is a perspective view of an evaporation device.

FIG. 13 is a perspective view of an evaporation device.

FIG. 14 is a perspective view of an evaporation device.

FIG. 15 is an evaporation device within a reactor portion.

FIG. 16 is an evaporation device within a reactor portion.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Unless otherwise stated, or clearly understood from the context of its use, reference herein to “exhaust stream” includes the stream of exhaust fluid initially emitted as a combustion reaction product from an engine, as well as any resulting fluid reaction products occasioned by an after-treatment step as described herein (e.g., a step of a DOC reaction, an SCR reaction, or other reaction, such as a thermolytic and/or hydrolytic reaction). The use of “untreated” may refer to the exhaust stream that has not yet been mixed with and/or reacted with a reactant. The use of “treated” or “mixed” may refer to the exhaust stream that has be mixed with and/or reacted with a reactant.

The apparatus includes one or more reactor portions. The reactor portions may function to house one or more mixers, react (or house a reaction) with an exhaust stream, remove particulates from the exhaust stream, house one or more filters, house one or more catalysts, receive one or more reactants, or any combination thereof. The one or more reactor portions may have any suitable size and/or shape for housing a mixer, being in communication with a reactant source, shape for reacting with an exhaust stream passing therethrough, removing particulate matter from the exhaust stream, directing the exhaust stream through the same or another reactor portion and/or apparatus, housing one or more other components, or any combination thereof. The one or more reactor portions may be generally cylindrical, cubed, spherical, coned, prismed, the like, or any combination thereof. One or more reactor portions may include one or more inlets, outlets, or both. An inlet may be an incoming end for an incoming fluid stream (e.g., exhaust) into the reactor portion. An on outlet may be an outgoing end for an outgoing fluid stream (e.g., exhaust, reactant) out of the reactor portion. A reactor portion may include a flow portion. A flow portion may be one or more segments of the reactor portion between an inlet and an outlet. One or more reactor portions may be tubular. One or more reactor portions may have generally the same or a differing shape as one or more other reactor portions. One or more reactor portions may have one or more sidewalls (e.g., walls) extending from one end to an opposing end. One or more reactor portions may include one or more inlets, outlets, or both. An inlet may be opposing an outlet. An inlet of one reactor portion may be adjacent an outlet of another reactor portion. One or more reactor portions may have a flow axis. One or more filters, catalysts, mixers, evaporation devices, and/or the like may be housed and/or enclosed within one or more reactor portions.

The apparatus includes one or more reactor portions. The reactor portions may function to house one or more mixers, react (or house a reaction) with an exhaust stream, remove particulates from the exhaust stream, house one or more filters, house one or more catalysts, receive one or more reactants, or any combination thereof. The one or more reactor portions may have any suitable size and/or shape for housing a mixer, being in communication with a reactant source, shape for reacting with an exhaust stream passing therethrough, removing particulate matter from the exhaust stream, directing the exhaust stream through the same or another reactor portion and/or apparatus, housing one or more other components, or any combination thereof. The one or more reactor portions may be generally cylindrical, cubed, spherical, coned, prismed, the like, or any combination thereof. One or more reactor portions may include one or more inlets, outlets, or both. An inlet may be an incoming end for an incoming fluid stream (e.g., exhaust) into the reactor portion. An on outlet may be an outgoing end for an outgoing fluid stream (e.g., exhaust, reactant) out of the reactor portion. A reactor portion may include a flow portion. A flow portion may be one or more segments of the reactor portion between an inlet and an outlet. One or more reactor portions may be tubular. One or more reactor portions may have generally the same or a differing shape as one or more other reactor portions. One or more reactor portions may have one or more sidewalls (e.g., walls) extending from one end to an opposing end. One or more reactor portions may include one or more inlets, outlets, or both. An inlet may be opposing an outlet. An inlet of one reactor portion may be adjacent an outlet of another reactor portion. One or more reactor portions may have a flow axis. One or more filters, catalysts, mixers, evaporation devices, and/or the like may be housed and/or enclosed within one or more reactor portions.

One or more reactor portions may include one or more upstream reactor portions, intermediate reactor portions, downstream reactor portions, or any combination thereof. Upstream, intermediate, and/or downstream may refer to the location of the reactor portions in relation to one another and the flow of fluid therein (e.g., exhaust stream). An upstream reactor portion may receive an exhaust stream and transmit to either one or more intermediate reactor portions, downstream reactor portions, or both. An intermediate reactor portion may receive an exhaust stream from one or more upstream reactor portions, intermediate reactor portions, or both. An intermediate reactor portion may transmit an exhaust stream to one or more other intermediate reactor portions, one or more downstream reactor portions, or both. A downstream reactor portion may receive an exhaust stream from one or more upstream reactor portions, intermediate reactor portions, or both. A downstream reactor portion may guide an exhaust stream toward an outlet, outlet pipe, or both. A mixer, evaporation device, fluid delivery device, or combination thereof may be part of any reactor portion. A mixer, evaporation device, fluid delivery device, or combination thereof may be part of an upstream, downstream, and/or intermediate reactor portion.

One or more reactor portions may have a generally same or differing length and/or width as one or more other reactor portions. Length may be measured along a flow axis, longitudinal axis, or both of a reactor portion. Length may be measured between an inlet and an outlet, from an inlet to an outlet, from rim to rim, or any combination thereof. Length may be measured where a width is substantially consistent, varying, or both. A reactor portion may have a length of about 12 inches or greater, about 15 inches or greater, or even about 20 inches or greater. A reactor portion may have a length of about 60 inches or less, about 40 inches or less, or even about 30 inches or less. For example, an intermediate reactor portion may have a length of about 20 inches to about 30 inches (e.g., about 25 inches). Width may be measured generally transverse to a flow axis and/or longitudinal axis of a reactor portion. Width may be measured as a width of a cross-section. Width may be measured as a diameter or other width measurement. A reactor portion may have a width of about 1 inch or greater, about 2 inches or greater, or even about 3 inches or greater. Width may be about 24 inches or less, about 15 inches or less, about 10 inches or less, or even about 7 inches or less. For example, an intermediate reactor portion may have a width of about 3 inches to about 7 inches (e.g., about 5 inches). One or more reactor portions may have a width which is substantially continuous. One or more reactor portions may have a width which increases, decreases, or both along a length of the reactor portion. For example, width may increase or decrease at an inlet and/or outlet (e.g., taper). A varying width may function to funnel and disperse the fluid flowing therethrough.

One or more reactor portions may be defined by a first end region and/or first end opposite a second end region and/or second end. A first end region may define an inlet of a reactor portion. A second end region may define an outlet of a reactor portion. Flow of an exhaust stream through a reactor portion may be from a first end region, first end, and/or inlet to a second end region, second end, and/or outlet. A first end region and/or first end may be in fluid communication with a second end region and/or second end via a flow portion. One or more reactor portions may be in fluid communication with one or more other reactor portions.

The one or more reactor portions may have a longitudinal axis (e.g., flow axis) extending along their respective length. The longitudinal axis may extend from a first end region of a reactor portion to a second end region of a reactor portion. A first end region may include an end (i.e., first end, inlet) of a reactor portion. A second end region may include an opposing end (i.e., second end, outlet) of a reactor portion. The longitudinal axis may be generally concentric or off-center with a cross-sectional area of a reactor portion. For example, a longitudinal axis may be concentric with a diameter of a reactor portion. The longitudinal axis of one or more reactor portions may be generally parallel with, perpendicular to, or any angle therebetween relative to the longitudinal axis of one or more other reactor portions. Generally, may mean within about 5°, within about 10°, or even within about 20° from the values stated. The longitudinal axis of one or more reactor portions may be concentric with, aligned with, un-centered from, off-set from, or any combination thereof relative to one or more other longitudinal axes of one or more other reactor portions. Longitudinal axes which are generally parallel with and off-set from one another may allow for the reactor portions to be consolidated and placed adjacent to one another (e.g., a box-style exhaust system). Longitudinal axes which are generally parallel with and substantially aligned with one another may allow for reactor portions to form an “in-line” exhaust system. A longitudinal axis may define an axis of a Cartesian coordinate system. The longitudinal axis may define an x-axis of each reactor portion. Generally transverse to the x-axis and/or longitudinal axis may be an y-axis and/or a z-axis. The y-axis, z-axis, or both may located at about a mid-length of a reactor portion. The differing axes may be useful in relating one or more components of the apparatus with one another, an exhaust stream passing through the apparatus, dimensions of one or more components, and the like. A longitudinal axis may be referred to as a flow axis (e.g., with reference to flow through a reactor portion of an exhaust stream).

A flow axis may indicate the direction of flow of an exhaust stream relative to a longitudinal axis, along a length of a reactor portion, along one or more passages of a mixer, or any combination thereof. A flow axis may extend from one end region to an opposing second end region. The flow axis of one or more components may flow in a same direction, transverse direction, and/or opposing direction as the flow axis of one or more other portions. One or more reactor portions may have a single flow axis or a plurality of flow axes. A reactor portion housing one or more mixers, deflectors, bends, or any combination thereof may include a plurality of flow axes which change the direction of flow therein. A plurality of flow axes may include a first flow axis, a second flow axis, a third flow axis, the like, or any combination thereof. The plurality of flow axes may be concentric or off-center with one another.

The apparatus may include one or more mixers. The one or more mixers may function to mix a reactant with an exhaust stream, provide a general uniform mixture of a reactant with the exhaust stream prior to entering one or more reactor portions, or both. The one or more mixers may have any size, shape, and or configuration to allow for mixing and/or optimizing a reaction of a reactant with the exhaust stream. The one or more mixers may be static, dynamic, or a combination of both. The one or more mixers may reside within, adjacent to, or proximate one or more reactor portions. The one or more mixers may reside between an inlet opening and an outlet of the reactor portion. The one or more mixers may reside within a same and/or different reactor portion as a reactor portion in which a reactant is introduced. One or more mixers may be located downstream and/or in-line with one or more evaporation devices. A static mixer may rely on one or more blades, openings, and/or flow paths to create turbulence of the exhaust stream and reactant flowing therethrough. The turbulence may provide for a sufficient amount of intensive mixing to allow for a substantially homogeneous mixture of the reactant and exhaust stream.

One benefit of the apparatus disclosed herein is that a mixer may be selected for providing a substantially uniform distribution of one or more reactants. For example, uniformity of distribution of a reactant with the exhaust stream. Uniformity of the reactant may be measured as a percentage, with 100% being perfect uniformity in parts per million values measured at a cross-section transverse to a flow axis. For example, dispersion of the reactant may be measured at cross-section of an inlet of a reactor portion (e.g., SCR inlet) and/or measured at a cross-section of an outlet of a reactor portion (e.g., SCR outlet). The mixer may result in uniformity of the reactant with the exhaust stream of about 90% or greater, 92% or greater, 95% or greater, or even about 98% or greater. The mixer may result in uniformity of the reactant with the exhaust stream of about 100% or less. The mixer may be an impingement or non-impingement mixer. Impingement may be defined as having one or more surfaces which the reactant contacts resulting in impact of the reactant with a surface of the mixer. Impingement may rely predominately on the impact for mixing. The impact may assist in evaporating water or other liquids from the reactant. Non-impingement may be defined as mixing which relies predominantly on turbulent flow.

A static mixer may be a radial blade mixer. A radial blade mixer may have a plurality of blades adjacent to one another in a circumferential direction while leaving free and defining a central core area. For example, a radial blade mixer may have one or more features such as those disclosed in US 20080267780, U.S. Pat. No. 8,495,866, incorporated herein by reference for all purposes. A radial blade mixer may be defined as an impingement mixer. A mixer may have a shape substantially similar to or differing from a cross-section of one or more reactor portions (e.g., cylindrical). The mixer may have a plurality of blades. The plurality of blades may point radially inward, outward, or both. The plurality of blades may be arranged radially within the mixer, about the mixer, or both. The plurality of blades may have an angle of incidence in relation to a flow axis one the mixer. The flow axis of the mixer may be parallel with, perpendicular to, or any angle therebetween relative to one or more flow axes of one or more reactor portions. One or more blades may or may not partially overlap one or more other blades. One or more blades may or may not extend completely toward a flow axis of the mixer. A central core area may be defined by a plurality of blades which do not extend completely toward the flow axis. The central core area may allow for passage of the exhaust stream and/or reactant therethrough. A plurality of blades may include two or more sets of blades. The two or more sets of blades may be distanced from one another along the flow axis of a mixer. For example, a first set of a plurality of blades may be located at one end of a mixer and a second set of a plurality of blades may be located at an opposing end of the mixer. Each set of blades may have the same or different characteristics as the one or more blades described herein. For example, both a first and second set of blades may be arranged radially within a mixer and define a central core area. One or more blades may be bifurcated. One or more blades may have one or more bends along a length of each blade. The angle of the bend may be acute, right angle, obtuse or any angle therebetween.

A static mixer may include a non-impingement mixer. A non-impingement mixer may function to redirect flow of an exhaust stream and/or reactant, convert laminar flow into turbulent flow and/or vice-versa of an exhaust stream and/or reactant, or both. A non-impingement mixer may be referred to as a baffle. A non-impingement mixer may include two opposing plate-like portions having a mixing tunnel therebetween, the mixer releasing one or more vortexes of an exhaust stream mixed with a reactant. The mixer may have one or more features such as those disclosed in PCT Publication No.: 2019/055922, US Publication No.: 2015/0110681, U.S. patent application Ser. No. 15/454,215 filed on Mar. 9, 2017, and German Patent Application DE 102016104361.3 filed Mar. 10, 2016, which are incorporated herein in their entirety by reference for all purposes. The static mixer may have any size, shape, and/or configuration to function as recited. The static mixer may have a shape which is generally cylindrical, cubed, sphered, coned, prismed, pyramided, the like, or any combination thereof. A static mixer may have a shape similar to or differing from that of one or more reactor portions. The static mixer may be in fluid communication with one or more reactor portions. The static mixer may be disposed within, adjacent to, or proximate to one or more reactor portions. The static mixer may be disposed between two or more reactor portions. A static mixer may have opposing ends (e.g., opposing plate-like portions). The mixer may include a rim. The rim may partially surround the one both of the opposing ends. The opposing ends may include an incoming end and an outgoing end. The incoming end may be a face of the static mixer which receives an exhaust stream, and/or faces toward an incoming flow of an exhaust stream. The outgoing end may be a face of the static mixer which faces releases an exhaust stream, is opposing the incoming face, and/or faces an outgoing exhaust stream (e.g., an exhaust stream mixed with a reactant). The static mixer may include a plurality of flow openings.

The apparatus may include one or more fluid delivery devices (e.g., valve, injector). The one or more fluid delivery devices may inject and/or control passage of a reactant into the apparatus, one or more reactor portions, one or more evaporation devices, one or more mixers, or a combination thereof; into contact with the exhaust stream; control flow of a reactant toward a reactor portion and/or mixer; or any combination thereof. The one or more fluid delivery devices may be any suitable device for releasing and controlling passing of a reactant into the apparatus. The one or more fluid delivery devices may be controlled by one or more controllers of a vehicle, exhaust system, or both. The controllers may determine a timing, amount, and the like of dosing. The one or more fluid delivery devices may include a single jet and/or nozzle or a plurality of jets and/or nozzles for releasing a reactant. The one or more fluid delivery devices may include 1 or more, 2 or more, or even 3 or more jets and/or spray nozzles. The one or more fluid delivery devices may include 10 or less, 8 or less, or even 6 or less jets and/or spray nozzles. The one or more fluid delivery devices may release a reactant in the form of a jet, a cone of liquid, and the like. The reactant, once emitted, may be released or break down into one or more droplets, film sections, and the like. The one or more fluid delivery devices may release a reactant having a droplet size. The droplet size may range be about 5 microns or greater, about 10 microns or greater, or even about 30 microns or greater. The droplet size may be about 180 microns or less, about 150 microns or less, or even about 50 microns or less. For example, droplet size may range from about 5 microns to about 50 microns. A smaller droplet size may allow for more efficient and homogeneous mixing of the reactant with the exhaust stream.

The one or more fluid delivery devices may be in fluid communication with one or more reactor portions. The one or more fluid delivery devices may be located in and/or on the apparatus, upstream of a mixer, affixed to a reactor portion (e.g., upstream reactor portion, intermediate reactor portion), affixed to an evaporation device, or a combination thereof. The one or more fluid delivery devices may be connected to and/or in fluid communication with one or more reactor portions. The one or more fluid delivery devices may be located upstream and/or downstream of a filter, catalyst, or both. The one or more fluid delivery devices may be affixed to an evaporation device. The one or more fluid delivery devices may be housed within an injector housing of an evaporation device. The one or more fluid delivery devices may inject a reactant into the apparatus such that the reactant flows generally perpendicular to, parallel with, or any angle therebetween relative to a flow axis of a reactor portion, direction of flow within an evaporation device, the direction of flow of the exhaust stream within a reactor portion and/or mixer, or a combination thereof. For example, an injector may be configured to spray a reactant into an evaporation device. The one or more fluid delivery devices may include a hydrocarbon doser, urea doser, or both. A hydrocarbon doser may inject hydrocarbon into a reactor portion. A hydrocarbon doser may inject the hydrocarbon as-needed when regeneration of a filter is necessary. A urea doser may inject urea into a reactor portion. A urea doser may inject urea on a regular basis.

One or more reactants may be introduced into the exhaust stream. One or more reactants may be particularly useful in aiding one or more subsequent reactions for filter regeneration, burning off particulate matter, or both. The one or more reactants may be introduced upstream of a catalyst, filter, mixer, or combination thereof. One or more reactants may be introduced by one or more fluid delivery devices (e.g., injectors). The one or more reactants may include any reactant capable of interacting (e.g., being exposed to) with one or more catalysts to maintain and or raise the temperature of the exhaust stream, maintain the catalyst in an active state, create a burn off reaction, aiding in filter regeneration, burning off particulate matter within the filter, the like, or any combination thereof. For example, the reactant may be configured to maintain or increase the temperature of the exhaust stream while the exhaust stream flows through the reactor portion. The one or more reactor portions may be located prior to a filter regeneration portion of the exhaust aftertreatment apparatus. The one or more reactants may be referred to as a thermal enhancer. The thermal enhancer may maintain or increase a temperature of a catalyst such that the catalyst is maintained or placed in an active state. For example, a reactor portion (e.g., intermediate) may be a thermal enhancer configured to maintain or increase the temperature of the exhaust stream passing therethrough prior to transmitting the exhaust stream to the downstream reactor portion. The reactant may react with a catalyst to combust and increase temperatures of a filter. The one or more reactants may include hydrocarbon. The reactant may be injected and mixed with an exhaust stream. The reactant may maintain and/or increase the overall temperature of the exhaust stream. The reactant may mix with the exhaust stream through a mixer, one or more passages, or both. The reactant may cause a chemical reaction upon contacting a catalyst, filter, or both. For example, a hydrocarbon may react with a diesel exothermic catalyst (“DEC”), a diesel oxidation catalyst (“DOC”), or both and burn off particulate matter within a subsequent particulate filter (e.g., a diesel particulate filter “DPF”).

As an alternative or in addition to, the one or more reactants may include an ammonia-based substance, such as an aqueous urea solution. Heat occurring in the apparatus may result in evaporation of water from the solution, resulting in urea. Heat may decompose the urea into one or more compounds. Upon decomposition, the urea may decompose into isocyanic acid and ammonia. The ammonia may be particularly useful in conjunction with a selective catalytic reactor. The one or more reactants may be introduced within a reactor portion, a mixer, or any other component in fluid communication with the exhaust stream upstream of reducing nitrogen oxides from the exhaust stream.

The apparatus may include one or more evaporation devices. An evaporation device may function to change the state of a reactant, convert a reactant from a liquid to a gaseous state (e.g., vaporize), or both. An evaporation device may function to raise a temperature of a reactant, function as a heat exchanger, or both. An evaporation device may be configured as a thermal conductor. An evaporation device may transfer heat from an exhaust stream to a reactant. An evaporation device may include an evaporation portion, injector housing, or both.

An evaporation device may include an evaporation portion. An evaporation portion may function as a thermal conductor to transfer heat from an exhaust stream to a reactant, vaporize a reactant, introduce a reactant into a reactor portion and/or exhaust stream; or any combination thereof. An evaporation portion may have any suitable shape and/or size for introducing a reactant into a reactor portion without significantly reducing the flow rate or available cross-section for a flow path of an exhaust stream through a reactor portion. An evaporation portion may be located downstream of an inlet, upstream of an outlet, or both. An evaporation portion may be located adjacent to an inlet. An evaporation portion may be located as close to an inlet as feasible so as to maximize length remaining of a reactor portion after a reactant is introduced into the exhaust stream for better mixing. An evaporation portion may be located upstream, downstream, or both from one or more mixers. An evaporation portion may be partially located within one or more mixers. An evaporation portion may be adjacent to a fluid delivery device, injector housing, or both. An evaporation portion may be located adjacent to, pass through, or both one or more side walls of a reactor portion. An evaporation portion may include an outer wall, one or more openings, one or more end walls, one or more portions or segments, one or more elbows, one or more fins, or any combination thereof.

The evaporation portion may have an overall length and/or width. A length of the evaporation portion may be measured from an injector wall to an end wall. A length may allow the reactant sufficient residence time within the evaporator device to change from a liquid to a gas. A width may be measured as a cross-section along flow axis of an evaporation portion. A length may be about 1 inch or greater, about 2 inches or greater, or even about 3 inches or greater. A length may be about 12 inches or less, about 10 inches or less, about 8 inches or less, or eve about 7 inches or less. For example, a length may be about 3 inches to about 6.5 inches. A width may be less than, equal to, or even greater than a length. A width may be about 0.5 inches or greater, about 1 inch or greater, or even about 1.5 inches or greater. A width may be about 5 inches or less, about 4 inches or less, or even about 3 inches or less.

An evaporation portion may include an outer wall. The outer wall may function as a thermal conductor, barrier of the reactant in liquid form from the exhaust stream, or both. The outer wall may form the overall structure and/or shape of the evaporation portion. The outer wall may be generally cylindrical, cubed, spherical, cones, prismed, the like, or any combination thereof. The outer wall may have a flow axis which is substantially linear, has one or more bends, or both. The outer wall may be located such that its longitudinal axis is substantially perpendicular to a flow of the exhaust stream. The outer wall may have one or more openings formed therethrough.

An evaporation portion includes a plurality of openings. The openings function to allow the vaporized reactant to exit the evaporation device and be introduced into the exhaust stream. The plurality of openings may be formed in an outer wall, end wall, or both. The plurality of openings may only be formed in the outer wall such that the end wall is prevented from releasing any reactant in liquid form. The plurality of openings may be located partially or completely about a circumference of an outer wall. The openings may be located about 90° or greater, about 135° or greater, or even 180° or greater of the circumference of the outer wall. The openings may be located about 360° or less, about 315° or less, or even about 270° or less of the circumference of the outer wall. The openings may be located along only a part of or all of the length of the outer wall. The openings may be located about 10% or greater, 25% or greater, or even 33% or greater of the overall length of the outer wall. The openings may be located along 100% or less, 75% or less, or even 66% or less of the overall length of the outer wall. The openings may be concentrated to one or more portions of the outer wall. Some of the openings may be concentrated toward an end wall, such as to allow the reactant a maximum amount of travel time throughout the evaporation device to vaporize. The one or more openings may be formed as one or more perforations. The openings may be unidirectional perforations, 360° perforations, or both.

An evaporation portion may include one or more walls. The one or more walls may function to close off the evaporation portion, prevent reactant in liquid form from escaping the evaporation device, or both. The evaporation portion may include an end wall. The end wall may be included within a reactor portion, furthest from a fluid delivery device, opposite an injector wall, or both. The end wall may be completely solid so as to prevent flow of a reactant therethrough. The end wall may have a cross-sectional shape reciprocal with the cross-sectional shape of the outer wall. Opposite the end wall may be an injector wall. An injector wall may function to support an injector housing, fluid delivery device, or both. An injector wall may include one or more apertures formed therethrough. The one or more apertures may be in fluid communication with an injector housing, fluid delivery device, or both. The one or more apertures may allow for a reactant to pass through into an evaporation portion.

An evaporation device may include an injector housing. An injector housing may function to house or otherwise support a fluid delivery device. An injector housing may project from an injector wall, opposite an evaporation portion, or both. An injector housing may pass through one or more side walls of a reactor portion. An injector housing may have any size and/or shape suitable for supporting or otherwise retaining at least a portion of a fluid delivery device.

The one or more reactor portions may include one or more filters. The one or more filters may function to collect and/or remove particulate matter from an exhaust stream, break apart larger sizes of particulate matter into smaller particles, carry one or more catalysts, or any combination thereof. Particulate matter may include soot residing within an exhaust stream of an internal combustion engine (e.g., diesel engine). The one or more filters may collect particulate matter on one or more surfaces of the filter (e.g., surfaces created by pores). Accumulated particulate matter may be removed through active, passive, and/or forced regeneration. The one or more filters may burn off accumulated particulate matter. Burning off of particulate matter may occur through a catalyst or a burner. Exemplary filters can be found in U.S. Pat. Nos. 8,336,301, 8,763,375, 9,074,522, 9,188,039, and 9,334,785, which are incorporated herein by reference for all purposes. Suitable filters may include cordierite wall flow filters, silicon carbide wall flow filters, ceramic fiber filters, metal fiber flow-through filters, partial filters, the like, or any combination thereof. Suitable filters may include one or more diesel and/or petrol filters. An exemplary filter may include a diesel particulate filter (“DPF”). The one or more filters may be located in, adjacent to, proximate with, and/or in fluid communication with one or more reactor portions. A filter may be located within a reactor portion, upstream and/or downstream of a mixer, upstream and/or downstream of a reactant, or a combination thereof. The one or more filters may carry a catalyst (e.g., coated with a catalyst) or be free of a catalyst. The one or more filters may be located adjacent to or distanced from a catalyst. The catalyst may allow a filter to also react with the exhaust stream in addition to removing particulate matter. For example, a filter may be adjacent to a diesel exothermic catalyst (“DEC”) and/or diesel oxidation catalyst (“DOC”) which has a chemical reaction with a reactant to result in filter regeneration and burning off of accumulated particulate matter.

The one or more reactor portions may include or be in communication with one or more catalysts. The one or more catalysts may be configured to initiate and/or perform one or more reactions. The one or more reactor portions may function to reduce toxic gasses, toxic pollutants, greenhouse gases, increase temperatures of an exhaust stream, initiate filter regeneration, or a combination thereof. Greenhouse gases may include carbon dioxide, methane, nitrous oxide, fluorinated gases, or any combination thereof. A filter regeneration portion may include a catalyst and a particulate filter. The one or more reactions may function to oxidize hydrocarbon, oxidize carbon monoxide, reduce hydrogen compounds, reduce nitrogen oxides, reduce sulfur oxides, oxidize methane, or any combination thereof. Exemplary catalysts may include a diesel oxidation catalyst (DOC), methane oxidation catalyst (MOC), selective catalytic reactor (SCR), ammonia slip catalyst (ACR), diesel exothermic catalyst (DEC), the like, or any combination thereof. The one or more catalysts may be located in one or more reactor portions. The one or more catalysts may be located within the same and/or a different reactor portion as one or more other catalysts and filters. One or more filters may function as a carrier and/or support structure for a catalyst. A plurality of catalysts may be placed in any sequence within the apparatus. As an example, selective catalytic reactor (SCR) may be located upstream of a diesel exothermic catalyst (DEC) and/or diesel oxidation catalyst (“DOC”). As an example, an upstream reactor portion may be configured to perform selective catalytic reduction. For an example, a downstream reactor portion may be configured to perform filter regeneration of a particulate filter located therein.

### ILLUSTRATIVE EXAMPLES

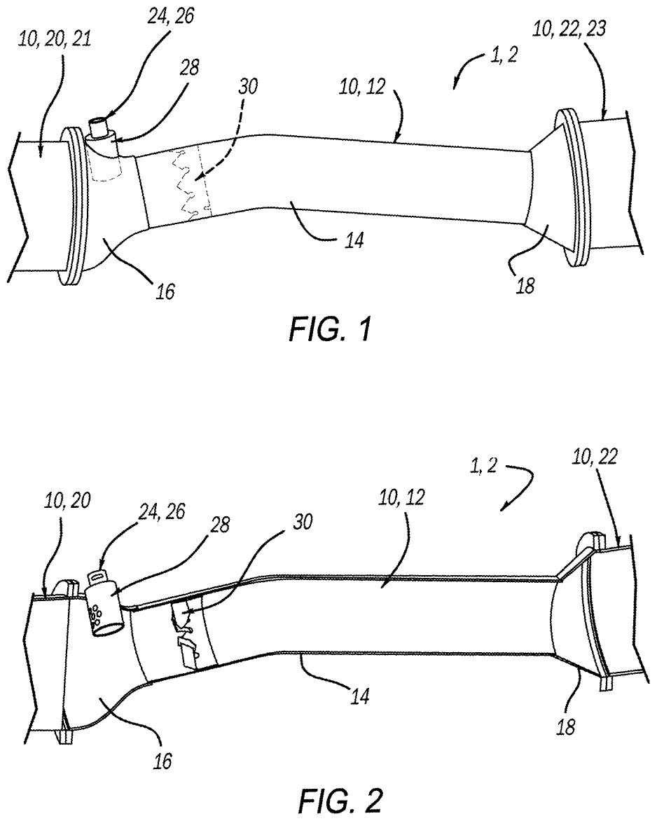

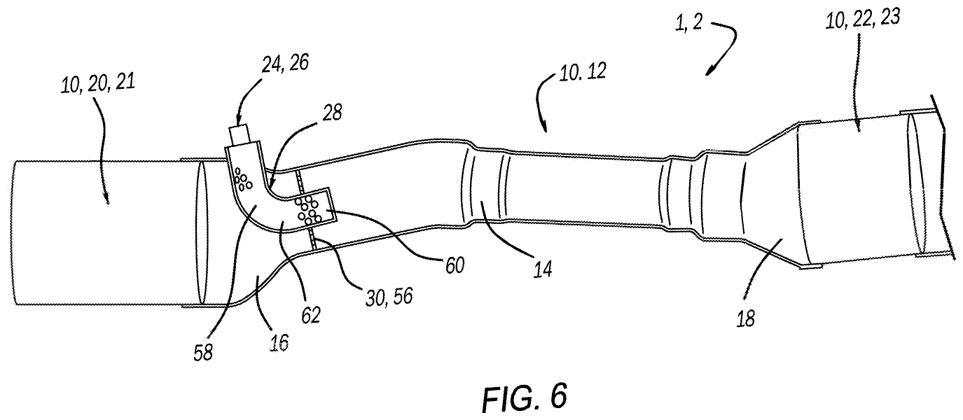

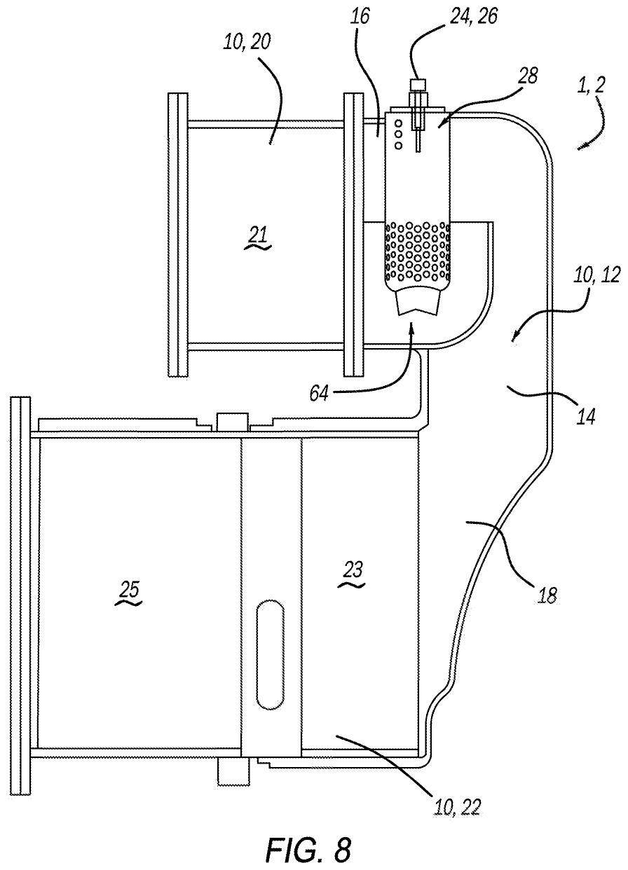

Features of one example may be combined with features of another example. For example, the evaporation device of FIG. 6 or 8 may be used as the evaporation device in FIG. 1. As another example, the mixing device of FIG. 6 may be used as the mixing device in FIG. 1.

FIGS. 1 and 2 illustrate an apparatus 1. The apparatus 1 is an exhaust aftertreatment apparatus 2. This apparatus 1 may be referred to as an in-line exhaust. The apparatus 1 includes a reactor portion 10. The reactor portion 10 may be referred to as an intermediate reactor portion 12. The reactor portion 10 includes a flow portion 14. The reactor portion 10 includes an inlet 16 at one end and an outlet 18 at an opposing end. In fluid communication with the reactor portion 10 is another reactor portion 10, which may be an upstream reactor portion 20. This reactor portion may be a selective catalytic reductant (SCR) 21. Opposite the upstream reactor portion 20 is another reactor portion 10. This reactor portion 10 may be a downstream reactor portion 22. This reactor portion 10 may be a diesel oxidation catalyst (DOC) 23.

The reactor portion 10 is in fluid communication with a fluid delivery device 24. It may be the intermediate reactor portion 12 which is in fluid communication with the fluid delivery device 24. The fluid delivery device 24 may be a fluid injector 26. The fluid delivery device 24 is configured to deliver a fluid, such as a reactant, in a flow perpendicular to the flow within the reactor portion 10. The reactor portion 10 is in fluid communication with the fluid delivery device 24 via an evaporation device 28. The evaporation device 28 is at least partially located within the reactor portion 10. The evaporation device 28 is located at or near the inlet 16 of the reactor portion 10.

Located within the reactor portion 10 is a mixing device 30. The mixing device 30 is located within the flow portion 14. The mixing device 30 may be configured as a blade mixer 32 (such as shown in FIG. 4). The mixing device 30 is positioned transverse to the flow within the flow portion 14. The mixing device 30 is located between the evaporation device 28 and the outlet 18.

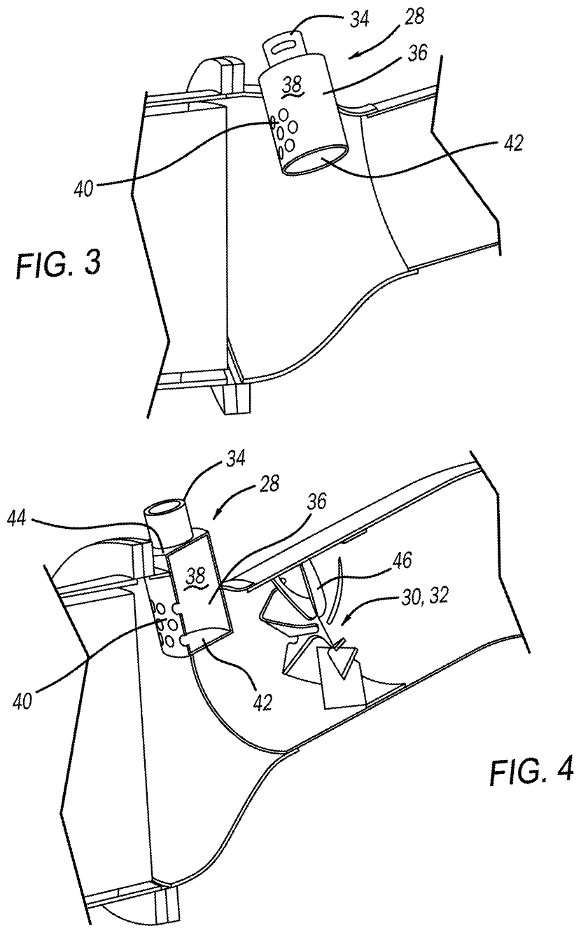

FIGS. 3 and 4 illustrate an evaporation device 28. The evaporation device 28 includes an injector housing 34. The evaporation device 28 includes an evaporation portion 36. The evaporation portion 36 has an outer wall 38. Formed in the outer wall 38 are a plurality of openings 40. The evaporation portion 36 includes an end wall 42. Opposite the end wall 42 is the injector wall 44.

FIG. 4 further illustrates a mixing device 30. The mixing device 30 is a blade mixer 32. The blade mixer 32 includes a plurality of blades 46. The blades 46 are radially arranged.

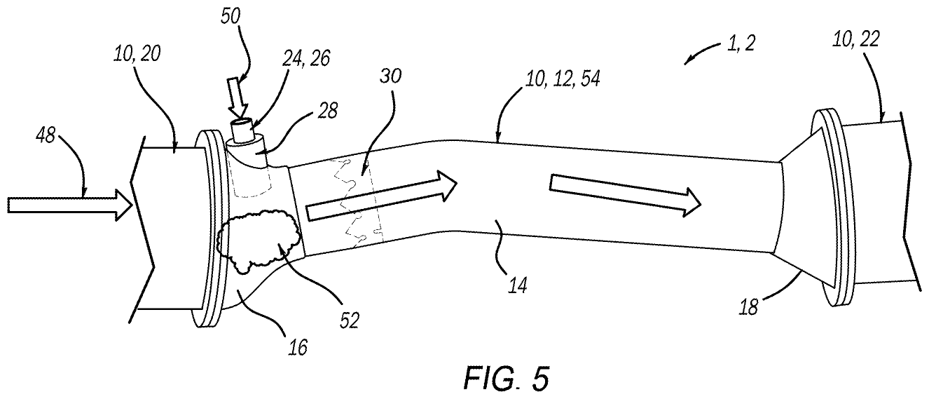

FIG. 5 illustrates a reactor portion 10 receiving an exhaust stream 48 via the inlet 16. The reactor portion may be an intermediate reactor portion 12. The intermediate reactor portion 12 may be referred to as a thermal enhancer 54. Downstream from the inlet 16, a reactant 50 is introduced. The reactant is delivered via a fluid delivery device 24. The reactor 50 is first received within an evaporation device 28. Within the evaporation device 28, the reactant 50 vaporizes. The reactant 50 vaporizes due to the heat within the evaporation device 28 and/or upon touching the surfaces of the evaporation portion 36, such as the outer wall 38 and/or end wall 44 (such as shown in FIGS. 3 and 4). The reactant 50 in vapor form escapes the evaporation device 28 via the plurality of openings 40 (such as shown in FIGS. 3 and 4). The reactant 50 in vapor form 52 is then introduced into the flow path of the exhaust stream 48. The exhaust stream 48 and the reactant 50 are guided through the flow portion 14 and toward the outlet 18 of the reactor portion 10. The exhaust stream 48 and reactant 50 begin and continue to mix with one another as soon as the reactant 50 is introduced into the exhaust stream 48. The exhaust stream 48 and reactant 50 are further mixed upon coming into contact with and/or passing through a mixing device 30. The exhaust stream 48 and reactant 50 continue to mix with one another as they flow through the flow portion 14 and exit the reactor portion 10 at the outlet 18.

FIG. 6 illustrates an apparatus 1. The apparatus 1 is an exhaust aftertreatment apparatus 2. The apparatus 1 includes a reactor portion 10. The reactor portion 10 may be referred to as an intermediate reactor portion 12. The reactor portion 10 includes a flow portion 14. The reactor portion 10 includes an inlet 16 at one end and an outlet 18 at an opposing end. In fluid communication with the reactor portion 10 is another reactor portion 10, which may be an upstream reactor portion 20. This reactor portion may be a selective catalytic reductant (SCR) 21. Opposing the upstream reactor portion 20 is another reactor portion 10. This reactor portion 10 may be a downstream reactor portion 22. This reactor portion 10 may be a diesel oxidation catalyst (DOC) 23.

The reactor portion 10 is in fluid communication with a fluid delivery device 24. The fluid delivery device may be a fluid injector 26. The fluid delivery device 24 is configured to deliver a fluid, such as a reactant, in a flow perpendicular to the flow within the reactor portion 10. The reactor portion 10 is in fluid communication with the fluid delivery device 24 via an evaporation device 28. The evaporation device 28 is at least partially located within the reactor portion 10. The evaporation device 28 is located at or near the inlet 16 of the reactor portion 10. The evaporation device 28 bends toward the flow axis of the flow portion 14. The evaporation device 28 includes a first portion 58 angled relative to a second portion 60 via an elbow 62. The second portion 60 is angled toward a mixing device 30.

Located within the reactor portion 10 is a mixing device 30. The mixing device 30 is located within the flow portion 14. The mixing device 30 may be configured as a baffle 56. The baffle 56 may include a plurality of openings (not shown) therein. The mixing device 30 is positioned transverse to the flow within the flow portion 14. A portion of the evaporation device 28 extends through the mixing device 30. The second portion 60 is concentric with the mixing device 30.

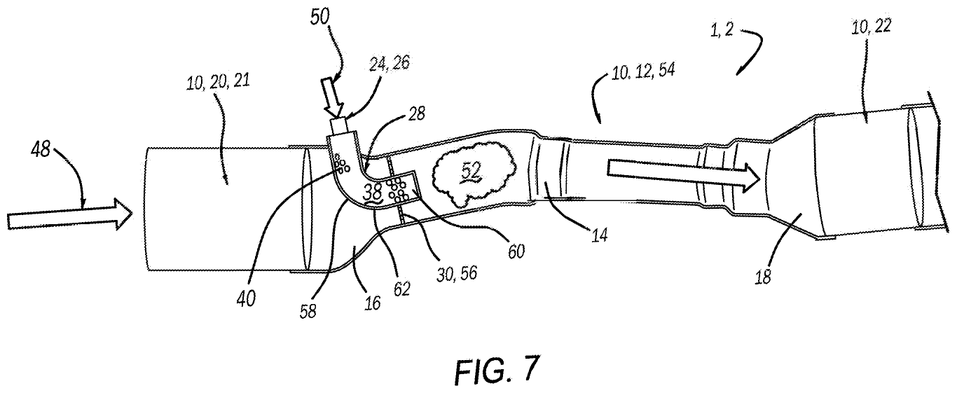

FIG. 7 illustrates a reactor portion 10 receiving an exhaust stream 48 via the inlet 16. The reactor portion may be an intermediate reactor portion 12. The intermediate reactor portion 12 may be referred to as a thermal enhancer 54. Downstream from the inlet 16, a reactant 50 is introduced. The reactant 50 is delivered via a fluid delivery device 24. The reactant 50 is first received within an evaporation device 28. Within the evaporation device 28, the reactant 50 vaporizes. The reactant 50 vaporizes due to the heat within the evaporation device 28 and/or upon touching surfaces of the evaporation portion 36, such as the outer wall 38 or end wall 44. The reactant 50 in vapor form escapes the evaporation device 28 via the plurality of openings 40. The reactant 50 is able to escape via openings 40 in the first portion 58 or second portion 60. The reactant 50 in vapor form 52 is then introduced into the flow path of the exhaust stream 48. The exhaust stream 48 and some of the reactant 50 may also pass through a mixing device 30. The mixing device 30 may create a turbulent flow to aid in mixing of the reactant 50 with the exhaust stream 48. The exhaust stream 48 and the reactant 50 are guided through the flow portion 14 and toward the outlet 18 of the reactor portion 10. The exhaust stream 48 and reactant 50 begin and continue to mix with one another as soon as the reactant 50 is introduced into the exhaust stream 48. The exhaust stream 48 and reactant 50 continue to mix with one another as they flow through the flow portion 14 and exit the reactor portion 10 at the outlet 18.

FIG. 8 illustrates an apparatus 1. The apparatus 1 is an exhaust aftertreatment apparatus 2. This apparatus 1 may be referred to as a box-style exhaust. The apparatus 1 includes a reactor portion 10. The reactor portion 10 may be referred to as an intermediate reactor portion 12. The reactor portion 10 includes a flow portion 14. The reactor portion 10 includes an inlet 16 at one end and an outlet 18 at an opposing end. In fluid communication with the reactor portion 10 is another reactor portion 10, which may be an upstream reactor portion 20. This reactor portion may be a selective catalytic reductant (SCR) 21. Also in fluid communication with the reactor portion 10 is another reactor portion 10. This reactor portion 10 may be a downstream reactor portion 22. This reactor portion 10 may include a diesel oxidation catalyst (DOC) 23 and diesel particulate filter (DPF) 25. The intermediate reactor portion 12 is transverse in flow to the downstream reactor portion 20 and upstream reactor portion 22.

The reactor portion 10 is in fluid communication with a fluid delivery device 24. The fluid delivery device may be a fluid injector 26. The fluid delivery device 24 is configured to deliver a fluid, such as a reactant 50, in a flow perpendicular to the initial flow within the reactor portion 10. The reactor portion 10 is in fluid communication with the fluid delivery device 24 via an evaporation device 28. The evaporation device 28 is at least partially located within the reactor portion 10. The evaporation device 28 is located at or near the inlet 16 of the reactor portion 10. The evaporation device 28 may be partially located within a deflector 64. The deflector 64 is located within the reactor portion 10. The deflector 64 is optional and adds additional mixing length within the flow portion 14.

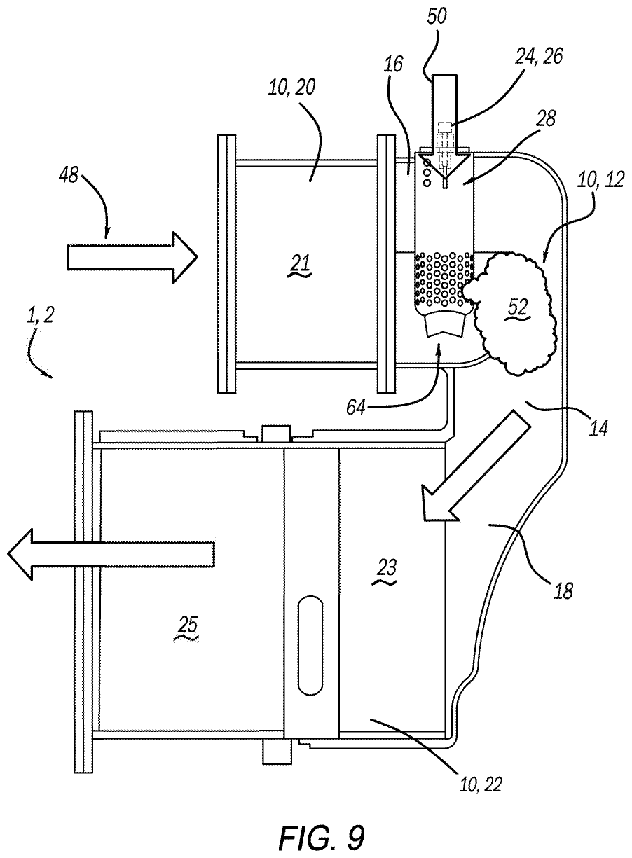

FIG. 9 illustrates a reactor portion 10 receiving an exhaust stream 48 via the inlet 16. The reactor portion may be an intermediate reactor portion 12. The intermediate reactor portion 12 may be referred to as a thermal enhancer 54. Downstream from the inlet 16, a reactant 50 is introduced. The reactant 50 is delivered via a fluid delivery device 24. The reactor 50 is first received within an evaporation device 28. Within the evaporation device 28, the reactant 50 vaporizes. The reactant 50 in vapor form escapes the evaporation device 28 via the plurality of openings 40. Some of the reactant 50 may be released into a deflector 64. The deflector 64 causes the reactant 50 in vapor form 52 to have turbulent flow as the reactor 50 is deflected back into the flow path of the exhaust stream. The reactant 50 in vapor form 52 is introduced into the flow path of the exhaust stream 48. The reactant 50 and exhaust stream 48 change directions through the flow portion 14 of the reactor portion 10. Disturbance in flow during each direction change may aid in mixing the reactant 50 with the exhaust stream 48. The exhaust stream 48 and the reactant 50 are guided through the flow portion 14 and toward the outlet 18 of the reactor portion 10. The exhaust stream 48 and reactant 50 continue to mix with one another as they flow through the flow portion 14 and exit the reactor portion 10 at the outlet 18.

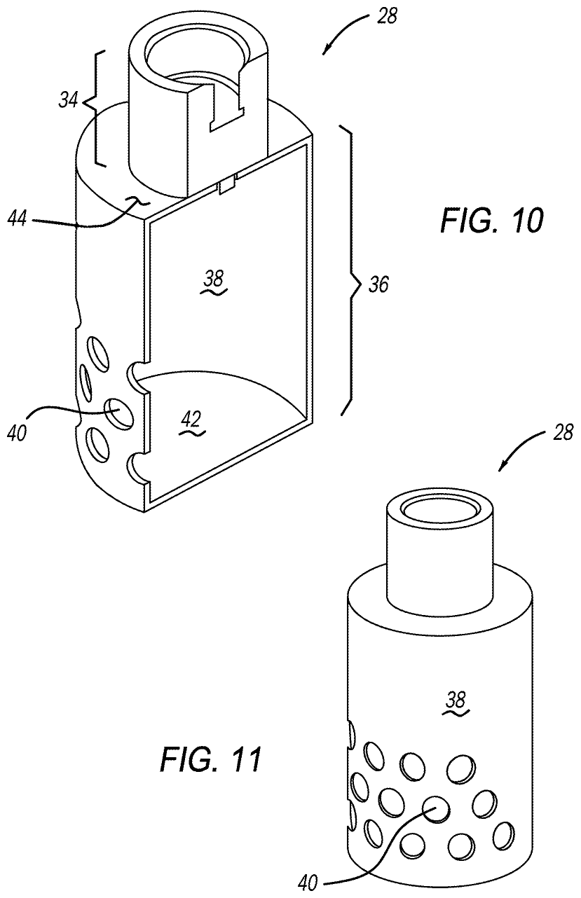

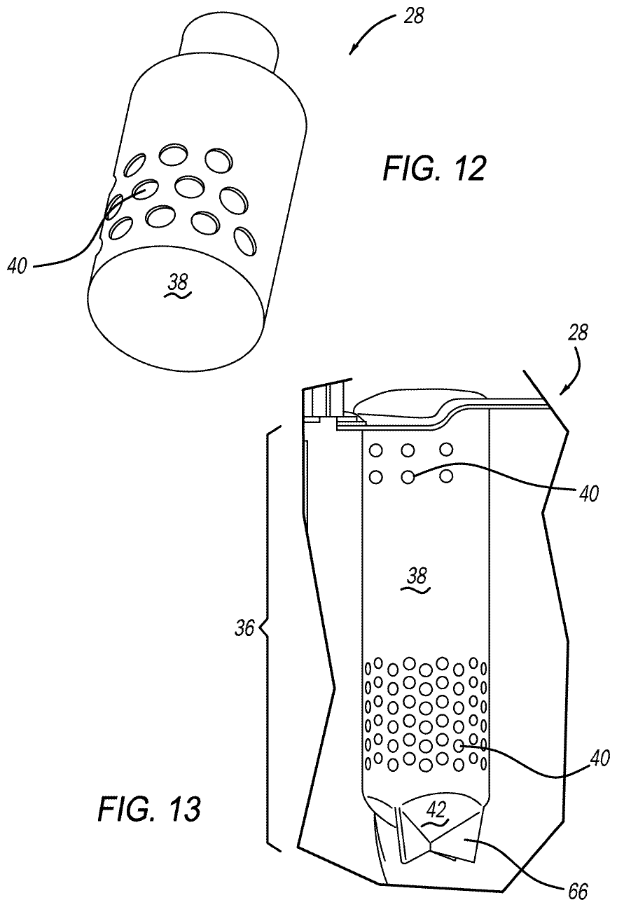

FIGS. 10-12 illustrate a close-up view of an evaporation device 28. The evaporation device 28 includes an evaporation portion 36. The evaporation portion 36 includes an outer wall 38. The outer wall 38 forms a substantially cylindrical shape. Formed in the outer wall 38 are a plurality of openings 40. The openings 40 are located only partially about the circumference of the outer wall 38 and only partially along the length of the outer wall 38. The outer wall 38 adjoins an end wall 42. Opposite the end wall 42 is another end wall 42. Opposite the end wall 42 is an injector wall 44. The injector wall 44 has an opening therethrough such that the evaporation portion 36 is in fluid communication with an injector housing 34. The injector housing 34 projects from the injector wall 44.

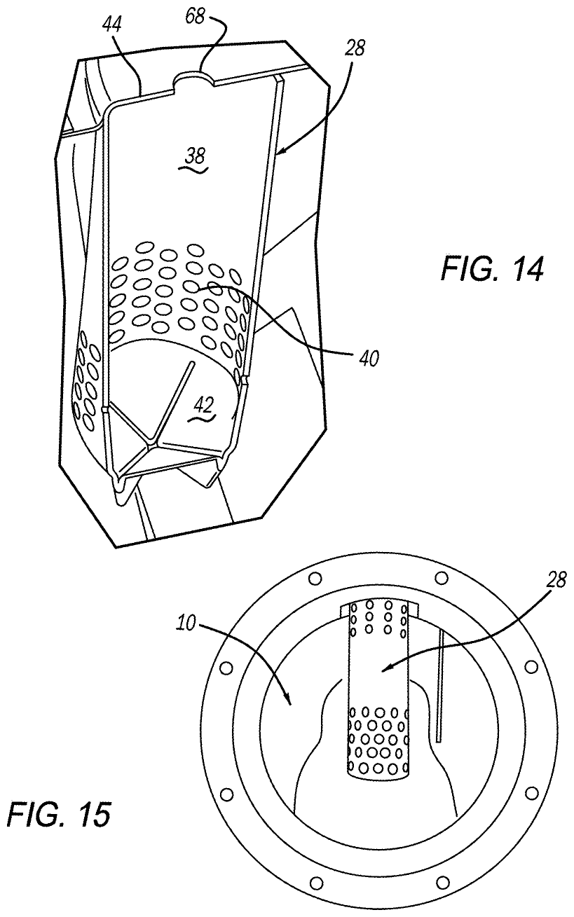

FIGS. 13 and 14 illustrate a close-up view of an evaporation device 28. The evaporation device 28 includes an evaporation portion 36. The evaporation portion 36 includes an outer wall 38. Formed in the outer wall 38 are a plurality of openings 40. The openings 40 are located at an upper and lower section of the evaporation portion 36. The upper section, the openings 40 are only located partially about the circumference of the outer wall 38. The lower section, the openings 40 are located entirely about the circumference of the outer wall 30. The outer wall 38 adjoins an end wall 42. Projecting from the end wall 42 are fins 66. The fins 66 are configured radially about the longitudinal axis of the evaporation device 28. Opposite the end wall 42 is an injector wall 44. The injector wall 44 includes an aperture 68. The aperture 68 allows for the evaporation portion 36 to receive a reactant 50 (not shown) from a fluid delivery device 24.

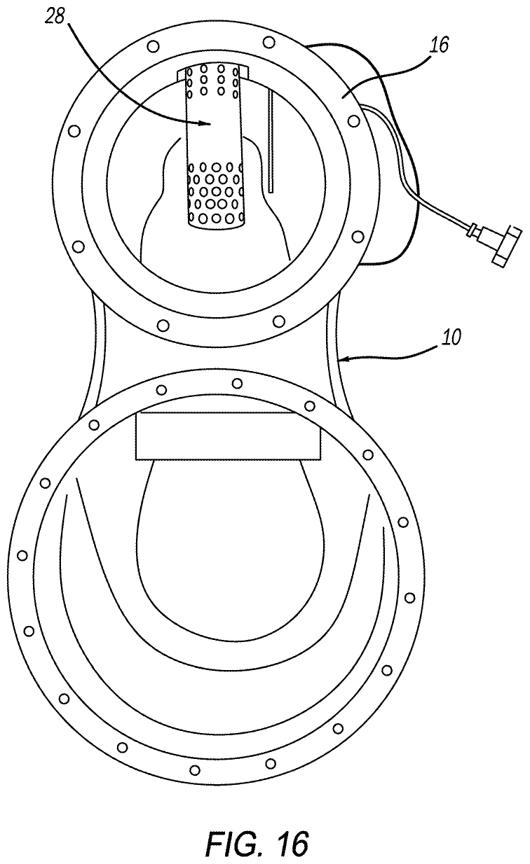

FIGS. 15 and 16 illustrate an evaporation device 28 within a reactor portion 10. The evaporation device 28 is adjacent to the inlet 16.

### WORKING EXAMPLES

Example A: FIGS. 1 and 2 illustrate an apparatus. The apparatus is made of stainless steel Type 441. The flow portion has a diameter of 5 inches and a length of 25 inches (between the inlet and outlets. The injector injects the reactant in the form of hydrocarbons at a mass flow rate of 110 mg/s to 1400 mg/s. The reactant vaporizes in the evaporation device and then enters into a flow portion. The reactant mixes with an exhaust stream, passes through a mixing device in the form of a blade mixer, then continues to flow through the flow portion of the reactor. The exhaust stream and reactant have a flow rate of about 100 kg/h to about 1700 kg/h. Upon reaching the outlet, the exhaust stream is mixed with a reactant such as to have a temperature uniformity of about 98% to about 99%. Performance in the upstream reactor portion, a diesel oxidation catalyst (DOC) is exothermic with a gas flow temperature of up to 900° C.

In this example, the evaporation device as illustrated in FIGS. 10-12 is utilized in the apparatus. The evaporation device has a tube diameter of 2 inches (e.g., diameter of evaporation portion). The evaporation device as a tube length of 3 inches (e.g., height from the end wall to the rim of the injector housing). The evaporation device includes a plurality of openings formed in the lower half of the height of the evaporation portion. The openings are formed as unidirectional, 360° perforations.

Example B: FIGS. 6 and 7 illustrate an apparatus. The apparatus is made of stainless steel Type 441. The flow portion has a 5 inch diameter and a length of 25 inches. The injector injects the reactant in the form of hydrocarbons at a mass flow rate of 110 mg/s to 1400 mg/s. The reactant vaporizes in the evaporation device and then enters into a flow portion. The reactant mixes with an exhaust stream, some mixing before the mixing device and some after the mixing device. The mixing device is in the form of a baffle. The exhaust stream and reactant have a flow rate of about 100 kg/h to about 1700 kg/h. Upon reaching the outlet, the exhaust stream is mixed with a reactant such as to have a temperature uniformity of about 98% to about 99%. Performance in the upstream reactor portion, a diesel oxidation catalyst (DOC) is exothermic with a gas flow temperature of up to 900° C.

Example C: FIGS. 8-9 illustrate an apparatus. The following example is without a deflector. The apparatus is made of stainless steel Type 441. The injector injects the reactant in the form of hydrocarbons at a mass flow rate of 110 mg/s to 885 mg/s. The reactant mixes with the exhaust stream through the flow portion and its changes in flow direction at the bends. The exhaust stream and reactant have a flow rate of about 100 kg/h to about 1700 kg/h. Upon reaching the outlet, the exhaust stream is mixed with a reactant such as to have a temperature uniformity of about 94% to about 97%. Performance in the upstream reactor portion, a diesel oxidation catalyst (DOC) is exothermic with a gas flow temperature of up to 500° C.

In Example C, the evaporation device as depicted in FIGS. 8-9 and 13-14 is utilized. The evaporation device has an evaporation portion having a tube diameter of 2¼ inches and a tube length of 6.5 inches. The openings have 360° perforation.

### REFERENCE NUMBERS

1—Apparatus
2—Exhaust aftertreatment apparatus
10—Reactor portion
12—Intermediate reactor portion
14—Flow portion
16—Inlet
18—Outlet
20—Upstream reactor portion
21—Selective catalytic reductant (SCR)
22—Downstream reactor portion
23—Diesel oxidation catalyst (DOC)
24—Fluid delivery device
25—Diesel particulate filter (DPF)
26—Fluid injector
28—Evaporation device
30—Mixing device
32—Blade mixer
34—Injector housing
36—Evaporation portion
38—Outer wall
40—Openings
42—End wall
44—Injector wall
46—Blades
48—Exhaust stream
50—Reactant in fluid form
52—Reactant in vapor form
54—Thermal enhancer
56—Baffle
58—First portion
60—Second portion
62—Elbow
64—Deflector
66—Fins
68—Aperture

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

What is claimed is:

1. An exhaust aftertreatment apparatus comprising:
a) a reactor portion with an inlet configured to receive an exhaust stream and opposite of an outlet, wherein a flow axis of the exhaust stream is substantially concentric with the reactor portion;
b) a fluid delivery device which a fluid injector configured to inject a reactant into the exhaust aftertreatment apparatus;
c) an evaporation device configured to be in receiving fluid communication with a fluid delivery device and comprising:
i) an evaporation portion having:
i-a) an outer wall;
i-b) a plurality of openings formed in the outer wall, wherein the plurality of openings are located about 90° or greater to about 270° or less of a circumference of the ter and wherein the plurality of openings are located about 10% or greater to about 75% or less a length of the outer wall, and wherein the plurality of openings are concentrated such that a majority face toward an oncoming direction of the exhaust stream;
i-c) a closed end; and
ii) an injector housing projecting from an injector wall and opposite the evaporation portion;
d) one or more mixing devices, wherein the evaporation device is located upstream of the one or more mixing devices, passes through one or more mixing devices, or both; and
wherein the evaporation device is configured to receive the reactant in liquid form from the fluid delivery device and allow the reactant to vaporize into gas form before exiting from the plurality of openings and mixing with the exhaust stream in the reactor portion.

2. The exhaust aftertreatment apparatus of claim 1, wherein the evaporation device is adjacent to and/or extends through a sidewall of the reactor portion.

3. The exhaust aftertreatment apparatus of claim 1, wherein the evaporation device is located at least partially transverse to the flow axis of the reactor portion.

4. The exhaust aftertreatment apparatus of claim 3, wherein the evaporation device is located adjacent to and downstream of the inlet, within an inlet, or both.

5. The exhaust aftertreatment apparatus of claim 4, wherein the evaporation device is located upstream of one or more mixing devices, passes through one or more mixing devices, or both.

6. (canceled)

7. (canceled)

8. (canceled)

9. (canceled)

10. The exhaust aftertreatment apparatus of claim 1, wherein the closed end is opposite the fluid delivery device.

11. (canceled)

12. The exhaust aftertreatment apparatus of claim 1, wherein the reactor portion is located prior to a filter regeneration portion of the exhaust aftertreatment apparatus.

13. The exhaust aftertreatment apparatus of claim 1, wherein the reactor portion is upstream of a catalyst, particulate filter, or both.

14. The exhaust aftertreatment apparatus of claim 13, wherein the reactor portion is upstream of a diesel oxidation catalyst, diesel particulate filter, or both.

15. The exhaust aftertreatment apparatus of claim 1, wherein the reactor portion is located downstream of a catalyst.

16. The exhaust aftertreatment apparatus of claim 15, wherein the reactor portion is located downstream of a selective catalytic reductant (SCR).

17. (canceled)

18. The exhaust aftertreatment apparatus of claim 1, wherein the reactant is hydrocarbon.

19. The exhaust aftertreatment apparatus of claim 1, wherein the fluid delivery device is a hydrocarbon doser.

20. The exhaust aftertreatment apparatus of claim 1, wherein the evaporation device has a length of about 2 inches or greater to about 12 inches or less; and
wherein the evaporation device has a width of about 0.5 inches or greater to about 6 inches or less.

21. (canceled)

22. The exhaust aftertreatment apparatus of claim 1, wherein the reactor portion is an intermediate reactor portion: and
wherein the intermediate reactor portion is downstream from an upstream reactor portion, upstream of a downstream reactor portion, or both.

23. (canceled)

24. The exhaust aftertreatment apparatus of claim 22, wherein the upstream reactor portion is configured to perform selective catalytic reduction.

25. The exhaust aftertreatment apparatus of claim 22, wherein the downstream reactor portion is configured to perform filter regeneration of a particulate filter located therein.

26. The exhaust aftertreatment apparatus claim 22, wherein the intermediate reactor portion is a thermal enhancer configured to maintain or increase the temperature of the exhaust stream passing therethrough prior to transmitting the exhaust stream to the downstream reactor portion.

27. The exhaust aftertreatment apparatus of claim 1, wherein the exhaust aftertreatment apparatus is configured to treat the exhaust stream from internal combustion of a transportation vehicle.

28. The exhaust aftertreatment apparatus of claim 1, wherein the closed end is an end wall.

29. (canceled)
